(19) United States
(12) Patent Application Publication
(10) Pub. No.: US 2008/0089433 A1
(43) Pub. Date: Apr. 17, 2008

(54) Method and apparatus for adapting to dynamic channel conditions in a multi-channel communication system

(76) Inventors: Jun Hyok Cho, Irvine, CA (US); Eugenio James Infusino, Long Beach, CA (US); Evangelos Petsalis, West Hollywood, CA (US); Michail Konstantinos Tsatsanis, Huntington Beach, CA (US)

Correspondence Address: WEIDE & MILLER, LTD., 7251 W. LAKE MEAD BLVD., SUITE 530, LAS VEGAS, NV, 89128, US

(21) Appl. No.: 11/580,706

(22) Filed: Oct. 13, 2006

(51) Int. Cl. H04L 1/02

(52) U.S. Cl. 375/267; 375/350

(57) ABSTRACT

A disturbance detection and fast re-train method and apparatus configured for use in a multi-channel communication is disclosed. During data communication disturbance detection occurs by monitoring error rates or other factors, such as crosstalk profiles. Upon detection of a disturbance, the system generates and transmits a line upset condition signal to an opposing terminal and monitors for a similar response from the opposing terminal. Channels which fail to convey such signals may be switch out of service. The signals received via the channels may be utilized as training signals to thereby yield a new crosstalk profile. The new crosstalk profile is processed to establish one or more new multiple input, multiple output filter coefficients, bit loading settings, and gain level settings. These new settings may exchanged with the opposing terminal. In addition, channels which, although transporting signals, yield CRC error rates over a pre-determined threshold, are removed from service.

### FIELD OF THE INVENTION

The invention relates to communication systems and in particular to a method and apparatus for detecting and adapting to dynamic channel conditions in a multi-channel communication system.

### RELATED ART

The growing popularity of electronic data exchange is increasing the demand for high rate data transmit speeds between remote locations. Multi-channel communication systems are often utilized to increase the rate of data exchange. The use of multiple channels can increase the effective transmit rate through use of advanced signal processing techniques. Examples include wireless communication systems with multiple transmit and multiple receive antennas and Ethernet systems (using four copper pairs per link).

One type of advanced signal processing technique adopted in multi-channel systems comprises multiple input, multiple output (MIMO) processing. MIMO type processing is capable of utilizing information regarding the signals on each of the channels, or the signals themselves, to generate cancellation signals that are tailored to cancel crosstalk or other unwanted noise that couples into each of the signals arriving at a multi-channel receiver. Hence, based on the received signal on each channel, the MIMO processing is capable of generating cancellation signals tailored to each of the other channels to thereby remove unwanted noise and crosstalk from each incoming signal. As a result of the MIMO processing, the channels may be configured to operate at higher effective data rates and over longer distances, as compared to systems that do not utilize MIMO processing.

In addition, for each channel, the amount a data, such as bits, and the power level at which such signals are transmitted may also be adjusted to further maximize the effective data rate. It is contemplated that absent the benefits of MIMO processing and bit loading, the channels would be unable to support communication at the implemented effective data transmit rate and over the distances provisioned due to unacceptably high levels of crosstalk or noise.

When a channel, either part of the multi-channel system or not, is activated or deactivated, it changes the crosstalk that couples into the other channels that are already in service. Likewise, other disturbers may also become active, which would in turn change the crosstalk profile for the various channels of a multi-channel communication system. Consequently, this crosstalk change disrupts the signals on the other channels. While normally such disruption could be mitigated or cancelled in the MIMO processing unit, if the MIMO processing unit is not trained to mitigate or cancel this new source of crosstalk, or lack thereof, then communication system operation may be disrupted.

As can be appreciated, it is highly undesirable for a modern communication system to suffer a noticeable service interruption. Such an event often results in customer complaints, lost data, inconvenience, and potential lost profit for the service provider. In addition, in the case of a multi-channel communication system, there may be an expectation that the system should be robust and remain operational due to the multiple different channels which support communication. As a result, there is a need in the art for a method and apparatus to maintain perceived reliability and insure that a multi-channel communication system is able to adapt to changes in environment. The present invention, which is described below in various embodiments, provides a solution to these drawbacks and provides additional benefits which are also discussed.

### SUMMARY

A disturbance detection and fast re-train method and apparatus configured for use in a multi-channel communication is disclosed. During data communication disturbance detection occurs by monitoring error rates or other factors, such as crosstalk profiles. Upon detection of a disturbance, the system generates and transmits a line upset condition (LUC) signal to an opposing terminal and monitors for a similar response from the opposing terminal. Channels which fail to convey such signals may have been blocked, disconnected or switched out of service. The signals received via the channels may be utilized as training signals to thereby yield a new crosstalk profile. The new crosstalk profile is processed to establish one or more new multiple input, multiple output filter coefficients, bit loading settings, and gain level settings. These new settings are exchanged with the opposing terminal to achieve communication based on the new crosstalk profile. In addition, channels which, although transporting signals appear to suffer from errors or other impairments during this exchange of information (e.g., yield CRC error rates over a pre-determined threshold), may be removed from service.

One example embodiment of the invention comprises a method for performing a fast retrain operation in a multi-channel communication system. This example method comprises monitoring an error rate associated with one or more channels of the multi-channel communication system for an error rate which exceeds an error rate threshold and monitoring for a LUC signal received from one or more opposing terminals. The LUC signal comprises an indicator from the one or more opposing terminals of a line upset condition. In response to a LUC signal or an error rate which exceeds an error rate threshold the system measures the noise on the one or more channels. Then, responsive to the noise on the one or more channels the system modifies one or more MIMO filter coefficients, and/or one or more bitloading parameter (bits per tone and gain coefficient) and using these coefficients, resumes data communication.

In one embodiment, this method further comprises monitoring for one or more channels, which have become inoperable, disconnected, or otherwise unreliable, and switching such channels out of operation. In addition, this method may further comprise transmitting a LUC signal to one or more opposing terminals in response to an error rate which exceeds an error rate threshold. Training information may be subsequently exchanged with the opposing terminal. It is contemplated that the method may also calculate new bit loading patterns or gain levels for the one or more channels based on the noise and that this information may be sent to the opposing terminal. In one embodiment the step of modifying one or more MIMO filter coefficients comprises recalling one or more MIMO filter coefficients from memory or may comprise setting the one or more MIMO filter coefficients to predetermined values to insure operation during a worst case noise scenario.

Also disclosed herein is a disturbance detection and fast retrain system for a multi-channel communication system. In one example embodiment, this system comprises one or more transmit/receive modules configured to transmit and receive data signals and a line upset condition via the one or more channels. A link disturbance detector is also provided and configured to monitor for and detect a disturbance on the one or more of the channels. A signal generator is configured to generate and transmit a line upset condition signal to an opposing terminal in response to a detection of a disturbance by the link disturbance detector. This embodiment also includes a processor configured to calculate one or more new noise parameters for the one or more channels in response to detection of a disturbance by the link disturbance detector and calculate one or more new filter coefficients based on the one or more new noise parameters. Based on the new filter coefficients, a multiple input, multiple output filter is configured to process data signals using the one or more new filter coefficients.

In one embodiment the new disturbance comprises a new disturber which generates crosstalk that couples into at least one of the one or more channels. It is contemplated that the disturbance may comprise a loss of one or more channels. It is further contemplated that the line upset condition signal may itself serve as, or be followed by a training signal to determine the new noise parameters and the new noise parameters are calculated for each channel. In one embodiment the system includes memory configured to store machine readable code such that the machine readable code is configured to execute on the processor. In addition, the processor may be further configured to determine which of the one or more channels did not receive a line upset condition signal or other acknowledgement signal from an opposing terminal and generate a control signal to switch such channels out of service.

Also disclosed herein is a system, for use in a multi-channel communication system, for detecting a disturbance and analyzing the disturbance. In one embodiment this system comprises one or more error rate monitors configured to detect an error rate of one or more channels of a multi-channel communication system and one or more comparators configured to compare the error rate to an error rate threshold. From this comparison a decision output is generated, which controls a signal generator to generate a line upset condition signal. A transceiver is also part of this embodiment and is configured to transmit the line upset condition signal to a remote communication terminal and monitor each channel for a line upset condition signal from the remote terminal. In turn, a processor configured to determine if the error rate is due to loss of one or more channels or a new disturber based on which of the channels provide a line upset condition signal from the remote terminal to the transceiver.

In one variation, the line upset condition signal transmitted on each channel may be uniquely identifiable to a particular channel. This system may further comprise an error rate monitor that is associated with each channel to monitor the error rate on the channel with which it is associated. This embodiment may further comprise a signal measurement unit configured to process the line upset condition as part of the analyzing the disturbance to determine noise on the one or more channels.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A and FIG. 1B illustrate two exemplary communication system configurations for use with the method and apparatus described herein.

FIG. 2 illustrates a block diagram of an example embodiment of the multi-channel communication system as described herein.

FIG. 3 illustrates a block diagram of example embodiment of the fast detection and adaptation control unit.

FIG. 4 illustrates an operational flow diagram of one example method of operation of the fast detection and adaptation system disclosed herein.

FIG. 5 illustrates a state diagram of an example operation pattern for disturbance monitoring and detection.

FIG. 6A-6C illustrate one possible example method of operation

### DETAILED DESCRIPTION

As way of general introduction, interference is often a major degradation factor limiting the performance of communication systems. In a single channel transmission system, intersymbol interference (ISI) is a major impairment and modern transceivers employ a variety of techniques to mitigate it, such as for example, channel equalization. In multi-channel communication systems there is further interference due to interactions across the communication channels. This interaction across communication channels is often referred to as crosstalk. For example, in wireline communications crosstalk is generated due to electromagnetic coupling when copper pairs travel in close proximity for long distances, or even short distances depending on the relative signal strengths. In wireless communications, crosstalk is generated when multiple users transmit signals whose energy partially overlaps in frequency and/or time.

Crosstalk is generally classified as near end (NEXT) or far end (FEXT) crosstalk depending on the location of the aggressor transmitter, i.e., whether the aggressor transmitter is at the near end or the far end in reference to the victim receiver. Furthermore, in the context of a multi-channel system, crosstalk is often classified as self or alien crosstalk. Self crosstalk originates from the transmitters which are part of the coordinated multi-channel transceiver. Alien crosstalk originates from the transmitters which are not part of the coordinated multi-channel transceiver. Alien crosstalk can be particularly troublesome because it originates from other transmitters or channels (e.g., legacy systems) that are not part of the system under design and to which the system under design does not have access to for purposes of crosstalk cancellation. As can be appreciated from this general overview, the crosstalk profile for a particular receiver is complex and unique to that particular receiver.

Prior art systems suffer from the drawback of being unable to adequately remove or account for unwanted crosstalk. As a result, the effective data transmit rate may be reduced below desired levels or below those levels that are desired or otherwise achievable. In other instances repeated occurrences of re-transmit requests may slow operation or changes in the crosstalk profile will disrupt operation of the communication system. This is especially problematic in multi-channel communication systems due to such systems primary function being efficient, reliable and high-speed data exchange.

As a result, multi-channel communication systems described herein employ advanced processing, such as for example MIMO type processing to counter the effects of the crosstalk. Because the multi-channel system utilizes multiple channels, the signals on the multiple channels may be cross-processed to generate cancellation signals. These cancellation systems may allow the effective rate of the multi-channel communication system to be greater than the combined rate of each individual channel operating independently. MIMO type processing is discussed in more detail in U.S. application Ser. No. 10,658,117, U.S. application Ser. No. 10/800,422, and U.S. application Ser. No. 10/717,702, which are hereby incorporated by reference herein.

To achieve the improved data transfer rate, the MIMO type processing, tailored or adapted to the particular crosstalk profile, is necessary. In addition, selective bit loading and transmit power level setting may be adopted on a per channel or per frequency bin basis. Numerous different events may change the crosstalk profile in the multi-channel communication system. Such events include, but are not limited to, loss of one or more channels, new disturbers or crosstalk, or any other factor that may change the cross talk profile. As can be appreciated, when the crosstalk profile changes from a first crosstalk profile to a second crosstalk profile, the MIMO processing, which is tailored to the first crosstalk profile, is no longer ideally tailored to the second crosstalk profile. As a result, the communication system may not be capable of sustaining data communication at the established rate. Because operation of MIMO type communication system is dependant on MIMO processing (and or bit/power level loading) tailored to the existing crosstalk profile, a change in the crosstalk profile will prevent operation of the entire multi-channel communication system. As discussed above, this is highly undesirable.

It is further noted in the event that the crosstalk profile changes, such as from loss of a channel, there are still numerous other channels, in the multi-channel communication system which are operational and can be utilized for data communications. Further, given the dependence on data communication and the reliability expectations of MIMO type systems, it would be undesirable to have the numerous operational channels idle due to only a few channels being lost. Although the data rate may be lower, it is assumed that a slight reduction in data rate is better than having the entire communication system inoperable.

Working from this general overview, disclosed herein is a method and apparatus for quickly and dynamically detecting the type of event that caused a change in crosstalk profile and reacting to the crosstalk profile change to maintain data communication.

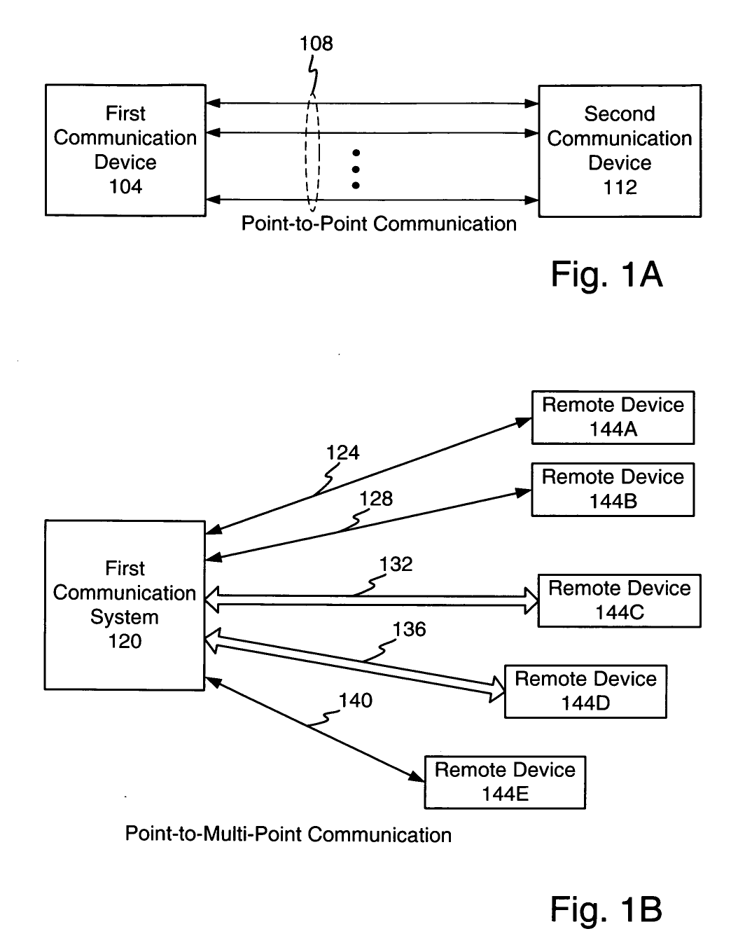

FIG. 1A and FIG. 1B illustrate two exemplary communication system configurations for use with the method and apparatus described herein. It is contemplated that the method and apparatus described herein may be applied to both point-to-point and point-to-multipoint communication systems and additional other communication system configurations as may be enabled by one or ordinary skill in the art.

FIG. 1A illustrates an example embodiment of a point-to-point communication system configuration. As shown a first communication device 104 communicates of a multi-channel communication path 108 with a second communication device 112. Through use of the multi-channel communication path and the processing as described herein, increased data transmit rates may be achieved, as compared to the prior art, while utilizing existing communication medium. It is contemplated that the multi-channel path 108 may comprises a wired, such as metallic conductor or optic path, or wireless or free space medium.

FIG. 1B illustrates an example embodiment of a point-to-multipoint communication system. As shown, a first communication system 120 communicates with two or more remote devices 144A, 144B, 144C, 144D, 144E via the communication paths 124, 128, 132, 136, 140. In this example embodiment communication paths 124, 128 and 140 comprise single channel communication paths while paths 132, 136 comprise multi-channel communication paths. Examples of point-to-multipoint communication systems include, but are not limited to a wireless base station that communicates with multiple mobile transceivers. Another example comprises a DSL access multiplexer in a telephone central office communicating with multiple customer DSL modems in a star network using one pair per customer. Of course, other configurations are possible that would likewise benefit from the teachings contained herein.

With regard to multi-channel communication path systems, multi-channel communication systems have found application in situations where one can utilize multiple communication channels to convey information. Examples include wireless communication systems with multiple transmit and multiple receive antennas, gigabit Ethernet systems (using four copper pairs per link), and DSL multi-pair transmission systems, to name but a few. Through the use of multi-channel paths and the method and apparatus described herein, synergy exists in that the overall bandwidth or data rate possible with the multi-channel path and associated signal processing is greater than the sum of an equal number of single channel communication systems operating individually, such as in a multiplexed configuration. As a result, information is transmitted and processed, both prior to and after transmission, in a coordinated fashion across all channels to maximally utilize the available physical transmission medium. As a result of these benefits, the method and apparatus described herein exploits the multi-channel path environment.

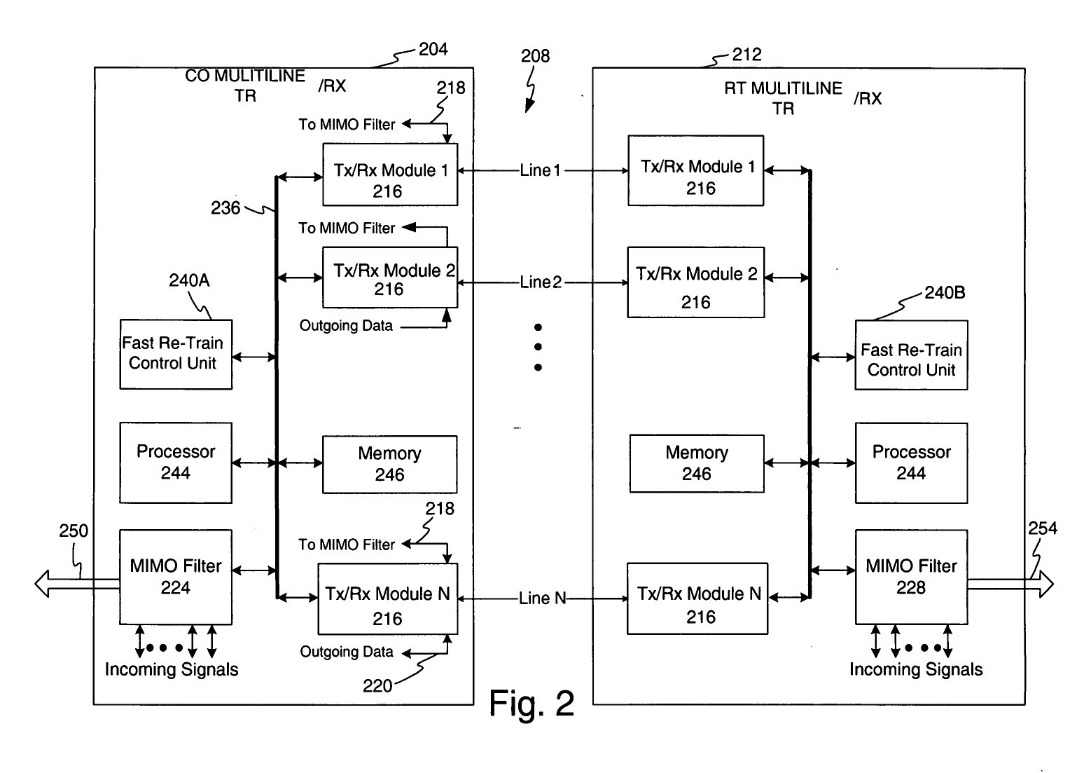

FIG. 2 illustrates a block diagram of an example embodiment of the multi-channel communication system as described herein. This is but one example embodiment of a multi-channel communication system with fast detection and adaptation capability. As shown, a communication device 204 located at a central office communicates over two or more channels 208 with a remote terminal 212. As used herein to aid in understanding, the central office communication device 204 may be referred to as a primary terminal. In this embodiment, each channel 208 communicates through a Tx/Rx module 216. The module 216 may comprise any I/O device capable of receiving and transmitting data while also performing the fast detection and adaptation functions as described herein.

Associated with each Tx/Rx module 216 are input and output ports. A data output port 218 associated with each physical layer device 216 is configured to provide the received data to a MIMO processing filter 224, 228. A data input port 220 is associated with each Tx/Rx module 216 and is configured to receive outgoing date, which in turn is processed by the Tx/Rx module and transmitted over the channels 208 to the opposing terminal. Signal outgoing from the communication devices 204, 212 are output via path 250, 254 as shown.

In this embodiment a shared bus 236 interconnects one or more devices within the transceivers 204, 212. In other embodiment, other means for communication between elements maybe utilized. The bus 236 allows for communication between the Tx/Rx module 216 and a control unit 240A, 240B, a processor 244, and a memory 246.

The processor 244 comprises any type processing element capable of performing processing. The processor 244 may comprise a microprocessor, ASIC, ARM, microcontroller, digital signal processor, or any other type of processing element. The processor 244 is configured to perform any type processing as may be described herein and may be configured to execute software, such as machine readable code, which may be stored in a memory 246. It is also contemplated that the processor 244 may be configured to generate one or more MIMO filter coefficients in addition to the processing associated with the fast detection and adaptation processes.

One or more memories 246 (hereinafter memory 246) is accessible over the shared bus 236. The memory 246 may be configured to store any type settings, data, filter coefficients, or other information. In one embodiment the memory 246 stores pre-determined or pre-calculated filter coefficients that correspond to one or more different crosstalk profiles, which may include crosstalk profiles representative if one or more channels are lost. This is discussed below in more detail. The memory 246 may comprise any type memory including RAM, ROM, EPROM, Flash type memory, optic memory, hard disk drive memory, or any other type of memory. The memory may be configured to store machine readable code.

A control unit 240A, 240B is also part the communication devices 204, 212 as shown. In this embodiment the control units 240A, 240B are configured to oversee and control the one or more aspects of the fast detection and adaptation to thereby detect changes in the cross talk profile, including the loss of one or more channels for active data communications. As can be appreciated after reading the discussion below, the control unit 240A may be different or identical to the control unit 240B due to potential differences in operation of the communication system 204 located at a central office as compared to the opposing communication system 212 located at a remote terminal.

Although numerous other functions and operations may be performed by the control units 240A, 240B, it is contemplated that the primary functions comprise detection of a change in conditions and fast adaptation to the change in conditions. The change in conditions may occur for any reason including a change in the crosstalk profile or a change in the number of channels in operation. It is possible not only that active channels may be lost during operation, but also the channels were previously lost or not active may be re-activated.

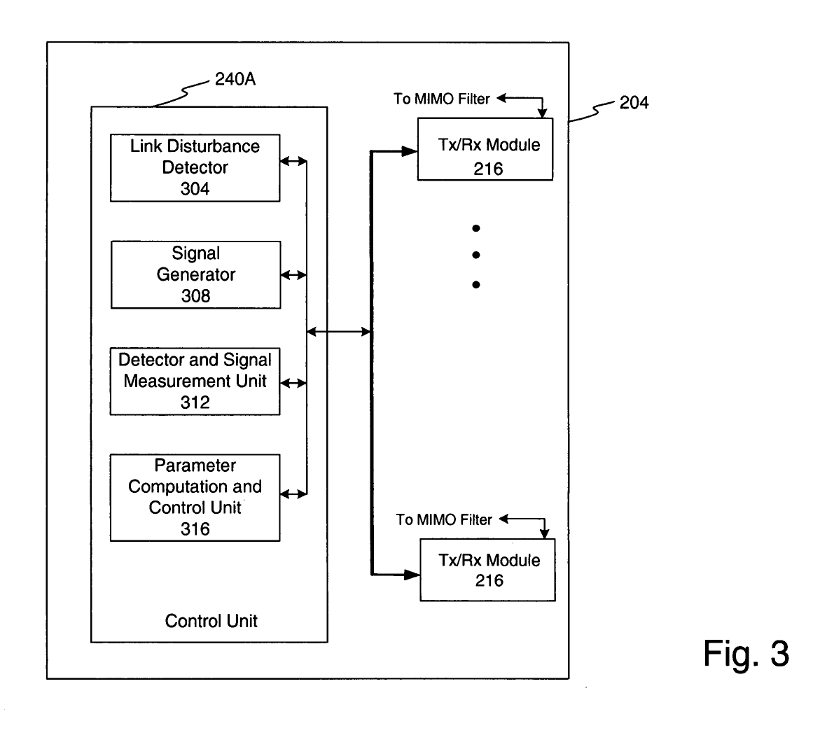

FIG. 3 illustrates a block diagram of example embodiment of the fast detection and adaptation control unit 204. This is one example configuration for the control unit 240A shown in FIG. 3 and it is contemplated that other embodiments and arrangements of elements may be created based on the teachings herein. In this Figure only the aspects of the control unit 204 are discussed in detail. It is contemplated that one of ordinary skill in the art would understand that additional elements may be provided to enable operation.

As shown, the control unit 240A comprises a link disturbance detector 304, a signal generator 308, a training signal measurement unit 312, and a parameter computation and control unit 316. Each of these elements 304, 308, 312, 316 are functionally discussed below. Each element 304, 308, 312, 316 may be configured in hardware, software, or a combination of both. As such, it is contemplated that each element may comprise any number of different configurations or structures, which may include machine readable code stored in memory.

The link disturbance detector 304 is configured to monitor the one or more channels for a disturbance. The disturbance may comprise any type disturbance that renders the link unreliable, including but not limited to one or more new disturbers being activated, one or more channels being lost, inoperable or disconnected, or one or more interruptions affecting the link due to voltage surges on the communication line, lightening discharge events, temporary ground faults, or other sudden external impairments or noise surges. The link disturbance detector 304 may detect the disturbance in any manner. In one embodiment the detector 304 detects an increase in error rate or an increase in the energy of the detection error signal. In one embodiment, the detector 304 monitors the impedance on the channel. In one embodiment, the detector 304 monitors the voltage or power level on the channel or the voltage or power level of the echo that is reflected back from the transmission medium. Finally, the link disturbance detector 304 may employ one or more of the above mentioned detection methods in various combinations to achieve the best possible detection results.

The link disturbance detector 304 interfaces with one or more other elements of the system. In one configuration, the detector 304 may monitor the MIMO filter output or other downstream processing elements to detect errors. In addition, upon detection of a disturbance, the detector 304 may generate an alert to one or more other elements of the communication system and/or the control unit 240A. As discussed below in connection with the operation of the system, upon detection of a disturbance, the system may rapidly respond to the disturbance to maintain active operation and minimize any drop out in service.

The signal generator 308 is configured to generate a signal, for transmission to the opposing terminal, for use in the fast detection and adaptation as described herein. In one configuration the signal generator 308 is configured to generate a line upset condition (LUC) signal for transmission to the other terminal when a disturbance is detected. The LUC signal, when sent, alerts the opposing terminal of the detected disturbance. Both terminals may then take appropriate action.

It is contemplated that in one embodiment, in response to the LUC signal, an opposing terminal may generate and transmit an acknowledgement signal. In one embodiment the acknowledgement signal has the same signal composition as the LUC signal.

The signal generator 308 may also generate a training signal. If necessary, the training signal may be transmitted to the opposing terminal, as a known sequence, to train one or more filters at the opposing terminal. In one embodiment the LUC signal serves as the training signal. In one embodiment the acknowledgement signal serves as the training signal. In one embodiment a signal other than the LUC or acknowledgement signal is the training signal.

In one embodiment a data signal is utilized as a training signal such that during operation data exchange may continue and the various aspects of the system may update and improve system settings using the data signal. This provides the benefit of further reducing communication system down time by allowing for data communication, albeit at a lower rate, during the training process. Hence, the communication link may be restored more rapidly than systems that utilized other than a data signal for training.

The signal detector and measurement unit 312 is configured to detect any type incoming signal. In one embodiment the signal detector and measurement unit 312 is configured to detect and monitor for an incoming LUC signal. Upon detection of a LUC signal the signal detector and measurement unit 312 may be configured to generate an alert to one or more elements in the receiving terminal of the received LUC signal. This alert notifies the receiving communication device of the line upset condition and may initiate operation of the fast retrain and adaptation process. The signal detector and measurement unit 312 may also be configured to detect and measure one or more aspects of a training signal from the opposing terminal. The training signal may be measured to determine the channel response, the SNR per frequency bin, the crosstalk profile and other useful information, which in turn may be processed to yield configuration parameters for the transceiver.

The parameter computation and control unit 316 is configured to calculate one or more parameters or control signals used to control, in the manner described herein, the fast detection and adaptation functions. In particular, the parameter computation and control unit 316 may be configured to calculate appropriate MIMO filter coefficients for the determined crosstalk profile, appropriate bits per tone and gains per tone parameters, appropriate receiver filter and equalizer coefficients and other useful physical layer processing parameters.

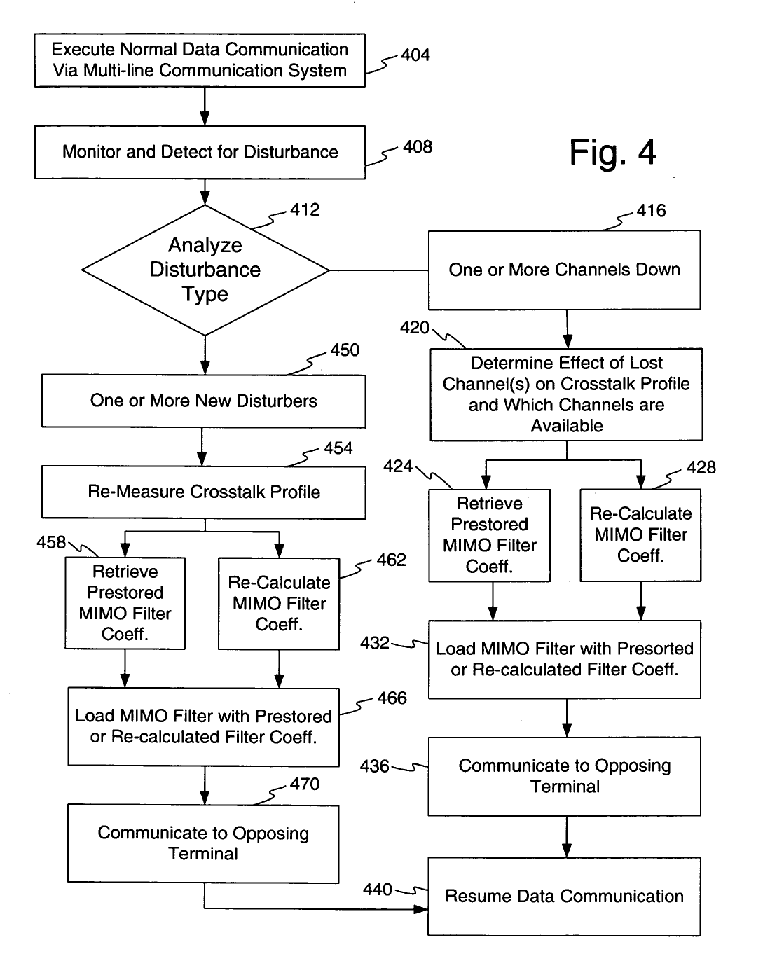

FIG. 4 illustrates an operational flow diagram of one example method of operation of the fast detection and adaptation system disclosed herein. This is but one possible example method of operation and as such, it is contemplated that other methods of operation may be enabled without departing from the claims that follow. This method outlines one possible method for a fast detection and adaptation. Fast detection and adaptation is in contrast to a full retrain operation which requires significant time to complete and will invariably bring down the communication system for an undesirably long period of time.

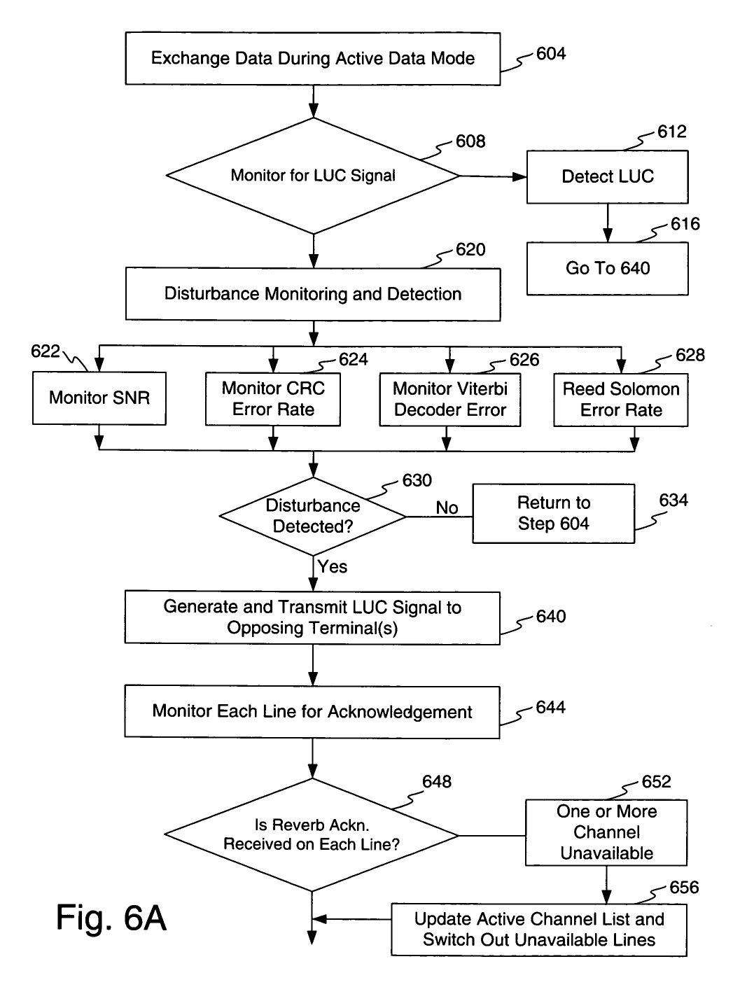

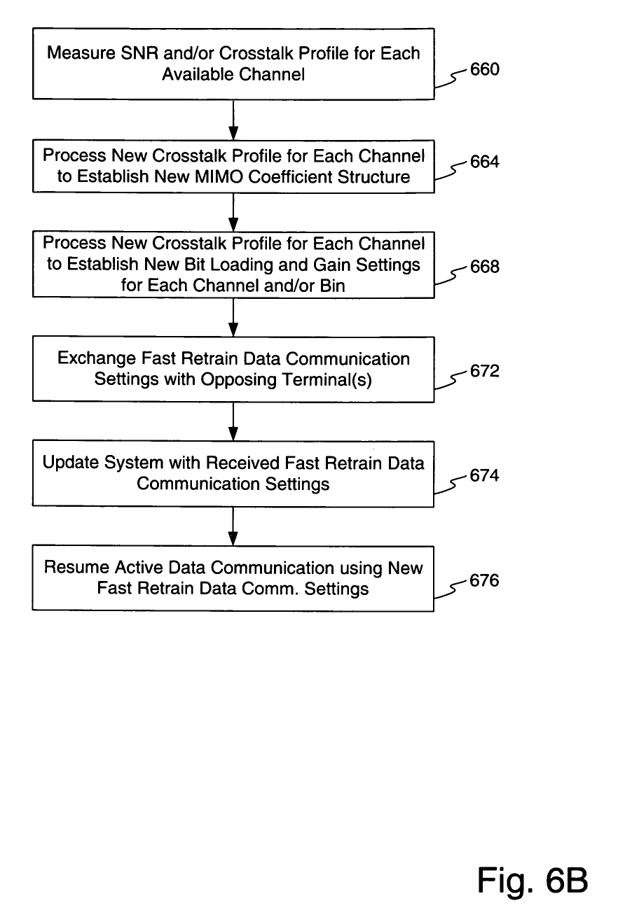

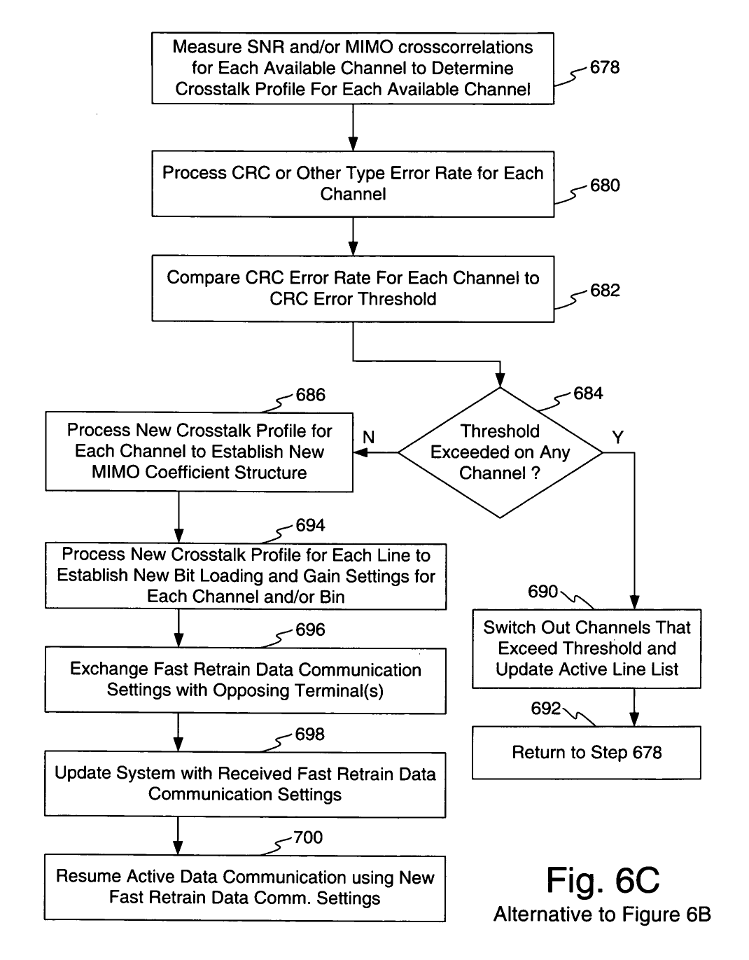

In this example method of operation, it is assumed that at step 404 the communication devices are exchanging data in the normal course of operation over one or more communication channels. Thereafter or concurrently, at a step 408 the communication system is monitoring for and detecting disturbances. In various different embodiments, disturbances can comprise or be detected in numerous different ways. A more detailed discussion of monitoring for and detecting disturbances is provided below in conjunction with FIG. 6. Examples of disturbances include, but are not limited to one or more new disturbers being activated, one or more channels being lost, inoperable or disconnected, and one or more interruptions affecting the link due to voltage surges on the communication line, lightening discharge events, temporary ground faults, or other sudden external impairments or noise surges. One method by which disturbances may be detected is to monitor for an increase in errors. Another method by which to detect disturbances comprises detecting changes in the voltage or impedance of the channel. Other detection methods include an increase in the energy of the detection error signal, or the voltage or power level of the echo that is reflected back from the transmission medium. For purposes of discussion, it is assumed that a disturbance was detected at step 408. Accordingly, at a step 412, an analysis occurs to determine the type of disturbance. In case the said disturbance is severe enough to cause momentary loss of synchronization between the central office communication device and the remote communication device (e.g., during a lightning strike), the step of 412 may take optional actions to adapt the receiver in order to restore the clock synchronization and frame synchronization between the two devices.

Although in other embodiments numerous different types of disturbances may be detected, in this particular embodiment, there are two different types of disturbances that may occur. Namely, one or more channels going down, such as being cut or interfered with in some way as to prevent data communication, or one or more new disturbers which may change the crosstalk profile. The process for analyzing the disturbance type may comprise any of different numerous steps and procedures.

Accordingly, if at step 412 the system determines that the disturbance is a result of one or more channels going down, then the operation advances to step 416. In this case, step 412 provides to step 416 detailed information about which channels are still operable and which have gone down. At step 416 the system initiates action in response to one more channels going down. It is contemplated numerous different actions may be taken. One such action occurs at step 420 wherein the system determines the effect of the lost channel(s) on the crosstalk profile and which channels are still available for communication. The crosstalk in the remaining channels may have changed due to lack of interference from the newly disconnected or inoperable channels. In one embodiment this comprises estimating, recalling from memory, or calculating the effect of the noise levels in the remaining lines utilizing the channel crosstalk coupling information and other information that has been available to the system during normal operation, without requiring an explicit noise re-measurement phase. Thus, in one embodiment therefore, the noise measurement re-training phase is not necessary. For example, the crosstalk profile for each line is known, but with a lost of a line, that crosstalk for that line is gone. Thus, only re-calculation may be required.

In one embodiment the new crosstalk profile is compared to the old crosstalk profile to determine the extent of the change. In one embodiment the crosstalk profile is determined based on the number of channels which are lost and/or the crosstalk contribution from each channel during normal operation. It is contemplated that in some embodiments the extent of crosstalk profile variation is not determine at this stage.

Based on the analysis and configuration of steps 416 and 420, the operation advances to either of step 424 or step 428 to take action to adapt to the loss of the one or more channels. By rapidly detecting the loss of the channel and adapting to the loss, the system is able to maintain data communication without disruption or minimize the down time. Depending on the extent of crosstalk variation, the system may take different actions to rapidly maintain or restore communication. For example, at step 424, the system may retrieve a pre-stored MIMO filter coefficient set from memory to replace the MIMO filter coefficient set that was in use just prior to the disturbance. As can be appreciated this may occur very quickly.

With regard to the pre-stored MIMO filter coefficient set, any number of different variations of MIMO filter coefficient sets may be calculated and pre-stored. In one embodiment a single filter coefficient set is stored in memory that is capable of maintaining operation regardless of which channel is lost. This stored filter coefficient set would be based on the current crosstalk profile, although it is assumed one channel would be lost from the current crosstalk profile. In one embodiment, if only a single filter coefficient set is stored for use at step 424, it may be a worst case coefficient set given the prior crosstalk profile.

Alternatively, multiple MIMO filter coefficient sets may be stored, each of which correspond to a particular one or more channels being lost. Thus, corresponding to each channel is a different filter coefficient set which is tailored to achieved operation in the event that particular corresponding channel is lost. In another embodiment, a number of different MIMO filter coefficient sets may be stored which may not correspond to the number of channels. Any one of these multiple MIMO filter coefficient sets may be selected based on which of the MIMO filter coefficient set would best establish the MIMO filter for maximum throughput for a given error rate.

Retrieval of pre-stored MIMO filter coefficient sets provides a rapid and accurate procedure for re-establishing the MIMO filter to reflect the new crosstalk profile. Thus, in the event of a loss of one or more channels, which will change the crosstalk profile, a MIMO filter coefficient set can be retrieved from memory which best matches the new crosstalk profile.

Alternatively, at step 428 the system may recalculate the MIMO filter coefficient set. It is contemplated that such upon detection and analysis of the disturbance, the system may, based on the new crosstalk profile and the remaining number of channels, re-calculate the MIMO filter coefficients. While the process of step 428 may take longer than that of step 424, the MIMO filter coefficient set would be custom to the new number of channels and the new crosstalk profile.

In one embodiment, according to the teachings of U.S. application Ser. No. 10,658,117, the MIMO coefficients for a multi-channel system are determined from the cross-channel correlation matrix via the application of a Cholesky decomposition. In this case, the correlation matrix can be modified to account for the lost one or more channels, and the Cholesky decomposition applied to the modified matrix. If only one channel is lost, faster variations of the Cholesky decomposition called rank-one updates can be utilized to calculate the new MIMO coefficients from the old ones.

Thereafter, the process advances to a step 432 where the system loads the new MIMO filter coefficient set to the MIMO filter. Then, at step 436 the operation may optionally communicate to the opposing terminal that new coefficients have been loaded and communication is to be resuming. It is contemplated that in one embodiment the opposing terminal may have to adjust its transmit parameters, such as bits per bin and power level. This is discussed below in more detail.

As a result of the fast detection and adaptation described above, at step 440, the system may resume data communication. The new MIMO filter coefficients re-enable operation of the communication system, albeit with one or more fewer channels.

If however, at step 412 the operation determines that the disturbance type is one or more new disturbers, then the operation advances to step 450. At step 450, the system initiates action in response to one more new disturbers. It is contemplated that numerous different actions may be taken. One such action occurs at step 454 wherein the system determines the extent of the change in the crosstalk profile due to the new disturbers. In one embodiment this may comprise exchanging training signals and measure noise on the channels or received training signals. The training signals can be MEDLEY or REVERB training signals. In another embodiment, a lower rate data carrying signal can serve as a training signal. In that case the lower rate data signal parameters are pre-agreed upon by the two modems and are such that reliable communication can be maintained (although at a lower rate) for all possible line disturbance scenarios. Based on the receiver reliably detecting the lower rate data signal, the required noise measurement and training can still be accomplished, while maintaining some link connectivity.

In one embodiment, the new crosstalk profile is compared to the old crosstalk profile to determine the extent of the change. In one embodiment the noise/crosstalk is measured, such as during a training process, to determine the extent of the change. It is contemplated that in some embodiments the extent of crosstalk profile variation is not determine at this stage.

Based on the analysis and configuration of steps 450 and 454, the operation advances to either of step 458 or step 462 to take action to adapt to the one or more new disturbers or different disturbers. By rapidly detecting the one or more different disturbers and adapting to the change in the crosstalk profile, the system is able to maintain data communication without disruption or minimize the down time.

Depending on the extent of crosstalk variation, the system may take different actions to rapidly maintain or restore communication. For example, at step 458, the system may retrieve a pre-stored MIMO filter coefficient set from memory to replace the MIMO filter coefficient set that was in use just prior to the disturbance. In one embodiment the pre-stored MIMO filter coefficients may be selected to enable operation in a worst case environment.

With regard to the pre-stored MIMO filter coefficient set, any number of different variations of MIMO filter coefficient sets may be calculated and pre-stored. In one embodiment a single filter coefficient set is stored in memory that is capable of maintaining operation regardless of the extent of the new disturbance, such as from one or more new disturbing channels. This stored filter coefficient set may be based on the current crosstalk profile. In one embodiment, if only a single filter coefficient set is stored for use at step 458, it may be a ‘worst case’ coefficient set which would insure operation for even the most undesired crosstalk profile.

Alternatively, multiple MIMO filter coefficient sets may be stored, each of which correspond to a particular set of new disturber circumstances. Thus, corresponding to a variety of different disturber scenarios, a different filter coefficient set which is tailored to achieve operation in the event that a particular new disturber scenario arises. In another embodiment, a number of different MIMO filter coefficient sets may be stored which may not corresponds to particular new disturber scenarios but instead cover a range of different crosstalk profiles. Any one of these multiple MIMO filter coefficient sets may be selected based on which of the MIMO filter coefficient set would best establish the MIMO filter for maximum throughput for a given error rate and the new crosstalk profile.

Retrieval of pre-stored MIMO filter coefficient sets provides a rapid and accurate procedure for re-establishing the MIMO filter to reflect the new crosstalk profile. In addition, a full retain operation may be avoided. Thus, in the event of one or more new disturbers or any different disturbance, which will change the crosstalk profile, a MIMO filter coefficient set can be retrieved from memory which best matches the new crosstalk profile.

Alternatively, at step 462 the system may recalculate the MIMO filter coefficient set. It is contemplated that such upon detection and analysis of the disturbance, the system may, based on the new crosstalk profile, re-calculate the MIMO filter coefficients. While the process of step 462 may take longer than that of step 458, the MIMO filter coefficient set would be custom to the new number of channels and the new cross talk profile and still take significantly less time than a full retrain.

In one embodiment, according to the teachings of U.S. application Ser. No. 10,658,117, the MIMO coefficients for a multichannel system are determined from the cross-channel correlation matrix via the application of a Cholesky decomposition. In this case, the correlation matrix can be modified to account for the one or more new disturbers, and the Cholesky decomposition applied to the modified matrix. If only one new disturber is present, faster variations of the Cholesky decomposition called rank-one updates can be utilized to calculate the new MIMO coefficients from the old ones.

Thereafter, the process advances to a step 466 where the system loads the new MIMO filter coefficient set to the MIMO filter. Then, at step 470 the operation may optionally communicate to the opposing terminal that new coefficients have been loaded and communication is to resume. It is contemplated that in one embodiment the opposing terminal may have to adjust its transmit parameters, such as bits per bin and power level.

It is also contemplated that both modems, such as the central office device and the remote device, may detect the disturbance at the same or similar time. If detected at the same or similar time, then the operation may advance as discussed herein with both sides performing the steps concurrently.

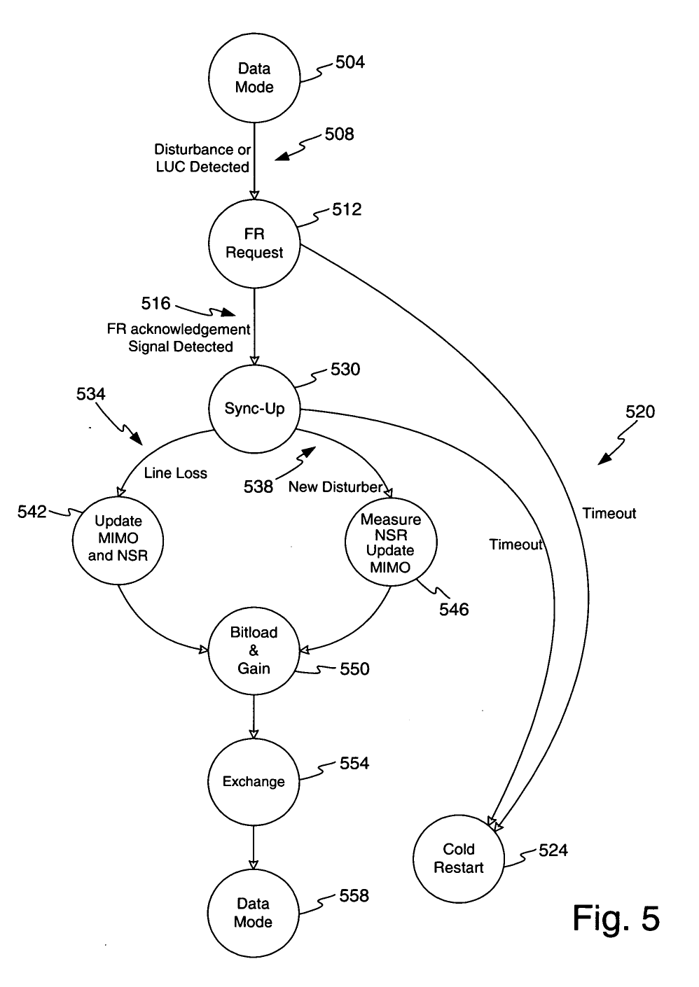

FIG. 5 illustrates a state diagram of an example operation flow for disturbance monitoring and detection. As was discussed above, upon detection of a disturbance, the multi-channel communication system would begin a process of disturbance analysis and interface with the one or more opposing communication terminals. The disturbance may be detected in any manner described herein or using any other detection means as would be understood now or in the future by one of ordinary skill in the art. As a point of reference, the two communication terminals are referred to as the primary communication terminal and the remote communication terminal. Because it is contemplated that each communication terminal may have similar capabilities, which communication terminals is defined as the remote terminal and which is the primary terminal is simply based on the point of reference.

This example state diagram starts at a state 504 wherein the communication system is in active data mode. From active data mode 504, a state change 508 occurs. State change 508 comprises a detection of a disturbance or detection of a LUC (line upset condition) signal. A LUC signal is sent from communication terminal when a disturbance is detected. It is contemplated that any terminal may detect and send the LUC signal. The LUC signal alerts the communication terminal receiving the LUC signal that the opposing terminal has detected a disturbance. Hence, at state change 508, during data mode one of the communication systems detects a disturbance or a LUC signal. This forces the system to advance to a state 512.

At state 512 the system generates a fast retrain (FR) signal, which is transmitted to the opposing terminal. In one embodiment, the FR signal may comprise the LUC signal. It is contemplated that either, or both, terminals may generate and transmit the FR signal. It is also contemplated that the FR signal can be sent as a response or acknowledgement to receiving the FR or LUC signal from the other (initiating) side. In either case, the FR signal is a signal sent in an attempt to initiate a fast re-train operation. Further, each channel transmits a unique version of the FR signal that carries channel identification information. This assists the receiving side in determining which channels are still active (ones for which channel identification has been successfully received) and which channels are inoperable (ones for which channel identification information has not been successfully received).

From state 512 the system may advance via state change 516 or 520. The system advances via transition 516 to state 530 if a FR acknowledgement signal is detected in response to the transmission of the FR signal.

If the FR acknowledgement signal is not detected, the state change 520 advances to a state 524 after a time out. At state 524 the system initiates a cold start. A cold start of state 524 is a full retrain operation and system reset and is generally less desirable than a fast retrain operation because a cold start consumes significantly more time thereby slowing the return the active data communication. The system advances into the cold retrain state 524 if the fast retrain operation fails.

If at state 512 the system advances through state change 516 by the opposing terminal detecting the reverb signal, then at a state 530 the two communication terminals, such as the primary terminal and the remote terminal, perform a sync function to synchronize operation. If the sync function is not completed, then the system advances through state change 520 to the cold start state 524.

Alternatively, the system may advance to state 542 or state 546. If the state change is a loss of a channel 542, then the system advances to state 542 wherein the system updates the MIMO filter coefficients and the noise to signal ratio. Bit loading and transmit power levels may also be adjusted. In this example embodiment, the loss of a channel may necessitate a new MIMO coefficient structure. The new MIMO coefficient structure could be quickly calculated, retrieved from a pre-stored set tailored for a particular channel loss scenario, or retrieved from a generic pre-stored MIMO coefficient structure. Regardless of the particular manner in which the MIMO coefficient structure is generated or obtained, the MIMO coefficient structure may be arrived at quickly and a time consuming cold restart of state 524 may be avoided.

If the state change is determined to be new disturber 536, then the system advances to state 546. The term new disturber is defined to mean any change to the crosstalk profile, including but not limited to, new disturbers, a loss of a disturber, or any other disturbance. At state 546 the system measures the new NSR for one or more channels of the multi-channel communication system and MIMO settings/coefficients may be updated. Because all of the channels remain in operation, the system may measure the effect of the new disturber on the over all noise picture. It is contemplated that in this embodiment the same MIMO coefficient structure may be utilized, although some of the values may change to account for the effect of the new disturber. In other embodiments, the new disturber may require new MIMO coefficient structure be quickly calculated, a pre-stored MIMO coefficient structure for a particular new disturber scenario be retrieved, or a generic pre-stored MIMO coefficient structure be retrieved. It is also contemplated that in any embodiment described herein the MIMO coefficient structure may remain unchanged during the fast retrain operation.

States 542, 546 advance to step 550 wherein the system calculates bit loading and may optionally calculate power distribution for each channel or each bin associated with each channel. In one embodiment the transmit power is set to unity for each channel or each bin associated with each channel. Thus, in addition to the option of modifying the MIMO coefficient structure, the bit loading and transmit power (gain) may be adjusted to account for the disturbance and the MIMO coefficient structure.

After the bit load and transmit power adjustment state 550, the system advances to state 554. At state 554 the system exchanges, between its terminals, any changes in operational parameters that has occurred at state 542, 546, and 550. Thus, at state 554, the system may exchange between terminals any of one or more modified MIMO coefficient structures, new bit loading patterns, and/or new transmit power level settings. As can be appreciated, it may be desirable to minimize the time required to complete the fast retrain operation and, as a result, the data exchanged during state 554, may be compressed or minimized. For example, use of repetitive settings across channels or bins may increase compression ratios or selection of a consistent transmit power level (such as for example unity gain) may reduce overall data content, which in turn reduces the time which is required to complete the data exchange of state 554.

After state 554, the system may return to active data mode using the new settings developed during the fast retrain operation. It is contemplated that in other embodiments different or additional states may be assumed which yield a fast retrain operation as described herein.

FIG. 6 illustrates another example method of operation. This is but one possible method of operation and one or more steps of FIG. 6 may be performed in any order and alone or in combination with other method steps disclosed herein. In FIG. 6A, it is assumed that at a step 604 the communication system be exchanging data and in active data mode. It is assumed that after installation of the communication system the system would undergo a cold start operation which would include the initialization of the entire system, including the detection of numerous channel characteristics and channel responses, establishing signal power levels and analog front end gain settings. In addition, analog to digital converter dynamic range settings would be implemented and hybrid echo settings established. Clock synchronization would occur and all the filters would be trained including the digital filters, such as FFE and DFE type filters and channel equalizers.

During operation however, a disturbance may occur that may disrupt operation of the communication system. To aid in understanding, this method of operation is discussed from the perspective of a primary terminal, which communicates with one or more opposing terminals. Accordingly at step 608 the communication system monitors for an indicator of a disturbance or a line upset condition from an opposing terminal. The indicator of a disturbance may comprise any type indicator, such as but not limited to an increase in error rate, loss of signal power level, or any other event. In this embodiment, if the opposing terminal detects a disturbance, it will generate and transmit a line upset condition (LUC) signal to the other terminal. Thus, if the opposing terminal detects a disturbance, the primary terminal will be alerted by detection of a LUC signal. In this example embodiment, the disturbance detection and fast retrain operation works the same in both the primary terminal and the opposing terminal.

From decision step 608, the operation advances to step 612 if a LUC signal is detected. The detection of a LUC signal is an indication that the opposing terminal has detected a disturbance and is requesting a fast retrain operation. From step 612 the operation advances to step 616 where the operation jumps to step 640, which is the start of the fast retrain operation. Alternatively, if at step 608 the operation determines that a LUC signal has not been detected, then the operation advances to step 620 wherein disturbance monitoring and detection occur.

It is contemplated that disturbance monitoring and detection may occur in any manner now known or developed in the future. In this example embodiment, any of one or more various different error rate monitoring may occur including, but not limited to, monitoring of the signal to noise ratio 622, monitoring of the CRC or packet error rate 624, monitoring of the Viterbi decoder 626, or monitoring the Reed-Solomon error rate 628.

During operation, disturbance detection may be occurring and the various error rate or other indicators may be monitored. At decision step 630 an error is not detected, then operation continues in active data mode and advances to step 634, which returns the operation to step 604.

Alternatively, if a disturbance is detected at step 630, then the operation advances to step 640 at which time the system generates and transmits a LUC signal to the one or more opposing terminals. This alerts the opposing terminal of the disturbance detection and is considered a request for entry into a fast retrain operation.

In response to the opposing terminal receiving the LUC signal, the opposing terminal will generate and transmit an acknowledgement signal. This occurs at a step 644. The acknowledgement signal may comprise the same signal as the LUC or a different signal. The acknowledgement is an indicator that the opposing terminal has detected the LUC signal and that the opposing terminal is entering the fast retrain operation. This exchange may comprise a sync-up operation wherein both or all terminals synchronize operation.

At a decision step 648 the operation monitors for the LUC acknowledgement on a channel by channel basis. If a LUC acknowledgement is not received on one or more channels, then the operation advances to step 652 wherein it assumed that, for whatever reason, one or more of the channels is not available. At a step 656 every channel on which a LUC acknowledgement signal is not received is switched out of the communication system. It is further contemplated that as part of the analysis, the system may determine that the crosstalk, noise, or other characteristic of a channel has so degraded performance that, although connected, the channel is effectively unusable. Such a channel could also be switched out of operation. Thus, data is not exchanged via switched out channels. The active channel list is updated to reflect only the channels that are deemed operational. Because in this embodiment the system is a multiple channel system with MIMO type processing, data is parsed between the various channels and processing on each channel is dependent on the number of channels in use and the crosstalk profile for each channel.

After step 656, the operation advances to either FIG. 6B or FIG. 6C, which should be considered in the alternative. Likewise, if at step 648 the reverb or LUC signal is detected on every channel then the operation advances directly to either FIG. 6B or FIG. 6C. It is again noted that FIG. 6B and FIG. 6C should be considered alternative in that after completing the process of FIG. 6A, the operation may advance to either FIG. 6B or FIG. 6C, which are different embodiments which may follow from FIG. 6A.

Turning to FIG. 6B, at a step 660, the system measures the signal to noise ratio (SNR or NSR) and one or more crosschannel correlation coefficients for each available channel to determine the crosstalk profile for each channel and/or the overall combination of channels. In one embodiment, the LUC or other forms of training signals (e.g., Reverb or Medley signals) are used for this aspect of analysis and training. In other embodiments, other or additional signals may be utilized. Due to the disturbance, which may comprise the loss of one or more channels, new disturbers which have been activated or deactivated, or any other event, the crosstalk profile may change which will in turn increase the error rate.

To account for the loss of the one or more channels or the new disturber, the MIMO filter coefficients may be changed. This occurs at step 664 wherein the new crosstalk profiles are processed to establish new MIMO coefficients structures. As discussed herein, this new MIMO filter structure may be calculated, pre-established, recalled from a memory, or may comprise no MIMO processing at all.

At step 668, the operation processes the new crosstalk profile for each channel to establish new bit loading and/or gain settings for each channel and/or bin. Based on the type or severity of the new disturber, the number of bits assigned for transmission over each channel or within each bin may be modified to suit the new crosstalk profile. In addition, the gain may be modified, or set to unity, or some other predetermined value. The benefit of setting gain to unity or a predetermined value is that the overall time required to complete the fast retrain is minimized.

Next, at step 672, the two or more communication systems (primary terminal and opposing terminal) exchange fast retrain data communication system settings. In one embodiment this comprises one or more of the following settings: MIMO coefficients, such as a precode MIMO filter coefficients, bit loading, and gains. In other embodiments other settings may be exchanged.

Thereafter, at a step 674, each communication system updates its hardware and/or software with the new settings established during the fast re-train operation. At a step 676, the system initiates active data communication using the new settings.

One benefit to the fast re-train operation is that it is faster than a cold start or full re-train operation. In a multi-channel communication system there is an expectation of greater reliability as compared to single channel communication systems. As a result, although a single channel may be lost or significantly disturbed, one or more other channels may remain unaffected or capable of operation. Thus, through use of the fast retrain operation, data exchange may be maintained at an equivalent, faster, or slower rate. Due to the MIMO aspect of filtering and the interdependency of each channel during processing, it may be necessary to modify one or more MIMO coefficients and or bit loading/gain settings. Thus, some adjustment of the settings may occur, but the time consuming and exhaustive restart and re-train process is avoided. For example, in the retrain process described herein, certain aspects of the process may remain unchanged, such as the A/D settings, hybrid echo settings, AFE gain settings, clock synchronization, and certain digital filters. By minimizing the time required to complete the fast retrain, active data operation is desirably resumed as soon as possible. In some instances the user may not realize the service has been temporarily lost.

As an alternative to FIG. 6B, FIG. 6C provides an alternative method of operation. The method of FIG. 6C is contemplated to occur in response to an intermittently operational channel, such as a single channel that suffers from intermittent or time varying errors. In such a situation, the channel may be capable of exchanging LUC and acknowledgement signals, but will soon change characteristics thereby repeatedly producing errors over time. Such a channel may continually force the communication system into fast retrain, but, because the channel may be capable of exchanging LUC/reverb signals, it will not be taken out of service at step 656 of FIG. 6A.

To account for this type of situation, the method of operation of FIG. 6C measures the signal to noise ratio (SNR or NSR) and one or more MIMO crosscorrelation coefficients for each available channel to determine the crosstalk profile for each channel and/or the overall combination of channels. In one embodiment, the LUC, reverb or medley training signals are used for this aspect of analysis and training. In other embodiments, additional signals or a different signal may be utilized. Due to the disturbance the overall crosstalk profile may change, which in turn increases the error rate. This all occurs at step 678.

Then, as part of the operation of step 678, the system monitors and processes the CRC rate or other type of error rate for each channel. If a channel suffers from intermittent or time varying errors, the CRC or other type error rate monitoring should detect such errors. At a step 682, the system compares the CRC error rate for each channel to a CRC error threshold. It is contemplated that the error threshold may be pre-stored, entered by an administrator, or calculated. A channel yielding intermittent or time varying errors will also yield a high CRC error rate. One example of a channel that may yield intermittent or time varying errors is a wet or damp twisted pair copper channel.

At decision step 684, based on the comparison of step 682, the system determines if the error rate exceeds the threshold. If the threshold is CRC error rate is exceeded, then the operation advances to step 690 wherein the system switches out the one or more channels which have the high error rates and updates the active channel list to include only channels which are still connected, i.e. not switched out of service. Then at step 692, the operation advances to step 678, wherein the operation may repeat.

Alternatively, if at decision step 684, the error threshold is not exceeded on any of the channels, then the operation advances to step 686. Steps 686 through step 700 the method performs as described in steps 664-676 as shown in FIG. 6B and a discussion of the method is not repeated. The prior discussed method steps are incorporated herein.

It is further contemplated that in any embodiment described herein further adaptation may occur to further improve data transfer rates and reduce the error rates. Thus, in one embodiment, the fast retrain operation generates initial MIMO filter coefficients and bit loading/gain which can be arrived at and implemented very quickly. Then, once operation has been restored, these settings may be fine tuned through adaptation to improve the data rate.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method for performing a fast retrain operation in a communication system, having one or more channels the method comprising:
monitoring for a disturbance on the one or more channels which exceeds a disturbance threshold;
monitoring for a LUC signal received from an opposing terminal, wherein the LUC signal comprising an indicator of a line upset condition;
in response to a LUC signal or a disturbance which exceeds the disturbance threshold, measuring a data or LUC signal on one or more channels to determine the extent of the disturbance;
responsive to the measuring, modifying one or more filter coefficients; and
resuming data communication using the one or more modified filter coefficients.

2. The method of claim 1, further comprising monitoring for a channel which is inactive and switching out of operation inactive channels.

3. The method of claim 1, further comprising transmitting a LUC signal to one or more opposing terminals in response to an disturbance which exceeds a disturbance threshold.

4. The method of claim 1, further comprising exchanging training information with the opposing terminal.

5. The method of claim 1, further comprising calculating a new bit loading pattern for the one or more channels based on the noise.

6. The method of claim 5, further comprising modifying one or more gain levels used during communication.

7. The method of claim 6, further comprising communicating the new bit loading pattern and the modified gain levels to an opposing terminal.

8. The method of claim 4, wherein modifying one or more filter coefficients comprises modifying one or more MIMO filter coefficients.

9. The method of claim 8, wherein modifying one or more MIMO filter coefficients comprises setting the one or more MIMO filter coefficients to predetermined values to insure operation during a worst case noise scenario.

10. A disturbance detection and fast retrain system for a multi-channel communication system comprising:
one or more transmit/receive modules configured to transmit and receive data signals and a line upset condition via the one or more channels;
a link disturbance detector configured to monitor for and detect a disturbance on the one or more of the channels;
a signal generator configured to generate and transmit a line upset condition signal to an opposing terminal in response to a detection of a disturbance by the link disturbance detector;
a processor configured to:
calculate one or more new noise parameters for the one or more channels in response to detection of a disturbance by the link disturbance detector; and
calculate one or more new filter coefficients based on the one or more new noise parameters;
a multiple input, multiple output filter configured to receive the one or more new filter coefficients, wherein the multiple input, multiple output filter is configured to process data signals using the one or more new filter coefficients.

11. The system of claim 10, wherein the disturbance comprises a new disturber which generates crosstalk that couples into at least one of the one or more channels.

12. The system of claim 10, wherein the disturbance comprises a loss of one or more channels.

13. The system of claim 10, wherein the line upset condition signal serves as a training signal to determine the new noise parameters and the new noise parameters are calculated for each channel.

14. The system of claim 10, further comprising memory configured to store machine readable code and wherein the machine readable code is configured to execute on the processor.

15. The system of claim 10, wherein the processor is further configured to determine which of the one or more channels did not a receive line upset condition signal or other acknowledgement signal from an opposing terminal and generate a control signal to switch such channels out of service.

16. A system, for use in a multi-channel communication system, for detecting a disturbance and analyzing the disturbance, the system comprising:
one or more error rate monitors configured to detect an error rate of one or more channels of a multi-channel communication system;
one or more comparators configured to compare the error rate to an error rate threshold and generate a decision output;
a signal generator configured to generate a line upset condition signal in response to the decision output;
a transceiver configured to transmit the line upset condition signal to a remote communication terminal and monitor each channel for a line upset condition signal from the remote terminal;
a processor configured to determine if the error rate is due to loss of one or more channels or a new disturber based on which of the channels provide a line upset condition signal from the remote terminal to the transceiver.

17. The system of claim 16, wherein the line upset condition signal transmitted on each channel is uniquely identifiable to a particular channel.

18. The system of claim 16, further comprising an error rate monitor is associated with each channel to monitor the error rate on the channel with which it is associated.

19. The system of claim 16, wherein the line upset condition is further utilized as a training signal.

20. The system of claim 16, further comprising a signal measurement unit configured to process the line upset condition as part of the analyzing the disturbance to determine noise on the one or more channels.

21. A method for performing a fast retrain operation in a communication system with a first modem and a second modem and one or more communication channels connecting them, the method comprising:
monitoring for a link disturbance associated with one or more channels of the communication system,
responsive to the link disturbance, sending a LUC signal from the first modem to the second modem;
responsive to receipt of a the LUC signal at the second modem, sending an acknowledgement signal from the second modem to the first modem and synchronizing with the first modem;
responsive to synchronization, training and measuring a subset of channel characteristics;
responsive to training and measuring, modifying modem parameters at the first modem;
communicating modem parameters to the second modem
modifying modem parameters at the second modem; and
resuming data communication using the modified modem parameters.

22. The method of claim 21, wherein the link disturbance is an increase in error rate.

23. The method of claim 21, wherein the LUC comprises a reverb signal.

24. The method of claim 21, wherein the acknowledgement signal comprises a reverb signal.

25. The method of claim 21, wherein synchronization is performed using a SEGUE signal.

26. The method of claim 21, wherein synchronization comprises a pilot signal phase and frequency estimation, and symbol frame boundary estimation.

27. The method of claim 21, wherein, the subset of channel characteristics comprises noise power per frequency bin.

28. The method of claim 21, wherein, the subset of channel characteristics comprises number of active channels.

29. The method of claim 21, wherein modem parameters which are modified comprises bits per frequency bin and gains per frequency bin.

30. The method of claim 21, wherein modem parameters which are modified comprise MIMO filter coefficients.

31. The method of claim 21, wherein communicating modem parameters comprises first compressing one or more modem parameters and then communicating one or more modem parameters.

32. The method of claim 21, wherein communicating modem parameters comprises setting a gain value to a predetermined value.

33. The method of claim 21, wherein training occurs with one or more of a LUC signal, an acknowledgement signal, or a data signal.

34. A method for removing a communication channel from operation in a communication system with a first modem and a second modem and two or more communication channels connecting them, the method comprising:
monitoring for a link disturbance associated with one or more channels of the communication system;
responsive to the link disturbance, sending an alert signal from the first modem to the second modem;
responsive to receipt of a the alert signal at the second modem, sending an acknowledgement signal from the second modem to the first modem and synchronizing with the first modem;
monitoring one or more modem parameters at the first modem or second modem or both for a modem parameter that exceeds a threshold;
responsive to an modem parameter associated with a channel that exceeds the threshold, disconnecting the channel that has a modem parameter that exceeds the threshold from the communication system; and
resuming data communication.

35. The method of claim 34, wherein the modem parameter comprises CRC error rate.

36. The method of claim 34, further comprising exchanging one or more signals between the first modem and the second modem to determine the one or more modem parameters.

37. The method of claim 34, wherein one or more modem parameter comprises an error rate that results in intermittent or time varying errors.

38. The method of claim 34, wherein the threshold comprises a maximum error rate.
